(19) United States
(12) Patent Application Publication
(10) Pub. No.: US 2013/0130064 A1
(43) Pub. Date: May 23, 2013

(54) ALUMINA DISPERSION FOR MANUFACTURING PARTICULATE MAGNETIC RECORDING MEDIUM, METHOD OF MANUFACTURING PARTICULATE MAGNETIC RECORDING MEDIUM USING THE SAME, AND PARTICULATE MAGNETIC RECORDING MEDIUM

(71) Applicant: Fujifilm Corporation, Tokyo (JP)

(72) Inventor: Masahide SATO, Minami-ashigara-shi (JP)

(73) Assignee: FUJIFILM CORPORATION, Tokyo (JP)

(21) Appl. No.: 13/682,207

(22) Filed: Nov. 20, 2012

(30) Foreign Application Priority Data
Nov. 21, 2011 (JP) 2011-254354
Nov. 16, 2012 (JP) 2012-251785

(51) Int. Cl. C09D 7/12

(52) U.S. Cl. CPC C09D 7/1233
USPC 428/837; 427/128; 106/287.17; 524/323; 524/324; 524/291

(57) ABSTRACT

An aspect of the present invention relates to an alumina dispersion, which is employed to manufacture a particulate magnetic recording medium, comprises alumina, a solvent, and a dispersing agent in the form of an aromatic hydrocarbon compound having a phenolic hydroxyl group, and essentially does not comprise ferromagnetic powder.

### CROSS-REFERENCE TO RELATED APPLICATIONS

This application claims the benefit of priority under 35 USC 119 to Japanese Patent Application No. 2011-254354 filed on Nov. 21, 2011 and Japanese Patent Application No. 2012-251785 filed on Nov. 16, 2012, which are expressly incorporated herein by reference in their entirety.

### BACKGROUND OF THE INVENTION

1. Field of the Invention

The present invention relates to an alumina dispersion employed to manufacture a particulate magnetic recording medium. More particularly, the present invention relates to an alumina dispersion which can be employed as an alumina abrasive dispersion for forming a magnetic layer of a particulate magnetic recording medium, a coating material to form a nonmagnetic layer, and the like.

The present invention further relates to a method of manufacturing a particulate magnetic recording medium employing the above alumina dispersion to form a magnetic layer, and to a particulate magnetic recording medium obtained by the above method.

2. Discussion of the Background

Magnetic recording media in the form of particulate magnetic recording media having a magnetic layer fabricated by coating a magnetic coating material, comprising ferromagnetic powder and a binder dispersed in a solvent, on a nonmagnetic support, and metal thin-film type magnetic recording media, having ferromagnetic powder deposited in the form of a film on a nonmagnetic support, are known. Particulate magnetic recording media are known to be superior from the perspectives of productivity and general-purpose properties.

Nonmagnetic inorganic powders are employed in particulate magnetic recording media to impart various properties. Among these, alumina is of relatively high hardness and is thus widely employed as a component in forming particulate magnetic recording media to inhibit fouling of the head by increasing the abrasiveness of the magnetic layer (see Japanese Unexamined Patent Publication (KOKAI) Heisei No. 8-45056 (Document 1), Japanese Unexamined Patent Publication (KOKAI) No. 2000-12315 (Document 2), Japanese Unexamined Patent Publication (KOKAI) Heisei No. 1-87672 (Document 3), Japanese Unexamined Patent Publication (KOKAI) Heisei No. 1-88914 (Document 4), Japanese Unexamined Patent Publication (KOKAI) Heisei No. 4-170713 (Document 5), and Japanese Unexamined Patent Publication (KOKAI) Heisei No. 4-319516 (Document 6), which are expressly incorporated herein by reference in their entirety.) and to increase the coating strength of nonmagnetic layers (see Japanese Unexamined Patent Publication (KOKAI) No. 2005-141882 (Document 7) or English language family members US2005/100762A1, U.S. Pat. No. 7,175,927, US2007/111040A1, and U.S. Pat. No. 7,517,598, which are expressly incorporated herein by reference in their entirety).

As set forth above, alumina is useful as a component for forming particulate magnetic recording media. However, when present in a magnetic layer or nonmagnetic layer as aggregated coarse particles without being adequately dispersed, the surface of the magnetic layer becomes coarse, causing signal loss and head abrasion. The nonuniform presence of alumina in the magnetic layer without adequate dispersion may cause uneven abrasion. In particular, alumina of α-phase crystalline form (α-alumina) is the hardest form of alumina. It is thus a desirable component from the perspectives of abrasiveness and coating hardness. However, the particles tend to become aspherical in shape, thus tending to render dispersibility poorer than alumina of other crystalline forms. The use of microparticulate alumina to enhance abrasiveness and the like tends to render dispersion difficult.

Known techniques for enhancing the dispersion of alumina include methods of specifying the number of polar groups or structure of the binder employed with the alumina (see Documents 1 and 2) and methods of surface treating alumina (see Documents 3 to 6). However, the alumina dispersion achieved by the above techniques is not necessarily adequate for manufacturing a particulate magnetic recording medium of the high surface smoothness required for achieving even higher recording densities.

### SUMMARY OF THE INVENTION

An aspect of the present invention provides for means for dispersing alumina to a high degree for the manufacturing of a particulate magnetic recording medium having good surface smoothness.

The present inventor conducted extensive research. As a result, he discovered that by dispersing alumina with an aromatic hydrocarbon compound comprising a phenolic hydroxyl group in a solvent, it was possible to obtain an alumina dispersion in which alumina was stably dispersed to a high degree. Although the reason for this is not completely clear, the present inventor has presumed that the aromatic hydrocarbon compound comprising a phenolic hydroxyl group can adsorb to the active points on the surface of the alumina, contributing to enhancing dispersion and dispersion stability. In this regard, when alumina is subjected to a dispersion treatment, the surface pH is known to constantly change This has been attributed to alumina powder being comminuted by dispersion treatment, forming new active points on the surface thereof. When new active points adsorb together, alumina aggregation is promoted. However, when an aromatic hydrocarbon compound having phenolic hydroxyl groups adsorbs to these active points, aggregation can be inhibited. As a result, it is presumed that the alumina can then be stably dispersed to a high degree.

The present invention was devised based on the above discovery.

An aspect of the present invention relates to an alumina dispersion, which is employed to manufacture a particulate magnetic recording medium, comprises alumina, a solvent, and a dispersing agent in the form of an aromatic hydrocarbon compound having a phenolic hydroxyl group, and essentially does not comprise ferromagnetic powder.

In one embodiment, the aromatic ring contained in the aromatic hydrocarbon compound is a benzene ring or a naphthalene ring.

In one embodiment, the aromatic hydrocarbon compound is selected from the group consisting of a compound denoted by general formula (1) and a compound denoted by general formula (2):

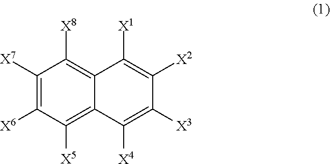

wherein, in general formula (1), two from among X¹ to X⁸ denote hydroxyl groups and each of the remaining portions independently denotes a hydrogen atom or a substituent;

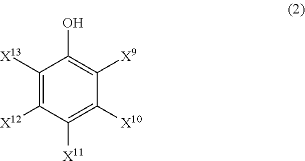

wherein, in general formula (2), each of X⁹ to X¹³ independently denotes a hydrogen atom or a substituent.

In one embodiment, the solvent is an organic solvent.

In one embodiment, the solvent comprises a ketone solvent.

In one embodiment, the above alumina dispersion further comprises a resin component.

In one embodiment, the above alumina dispersion further comprises a resin component selected from the group consisting of a polyurethane resin and a vinyl chloride resin.

In one embodiment, the above alumina dispersion is employed for preparation of a coating material for forming a magnetic layer of a particulate magnetic recording medium.

In one embodiment, the alumina is α-alumina.

In one embodiment, the aromatic hydrocarbon compound is selected from the group consisting of dihydroxylnaphthalene, phenol, hydroxybenzoic acid, and derivatives thereof.

In one embodiment, the above alumina dispersion comprises the dispersing agent in an amount ranging from 2 to 20 weight parts per 100 weight parts of the alumina.

In one embodiment, the specific surface area by BET method of the alumina is equal to or higher than 14 m²/g.

A further aspect of the present invention relates to a method of manufacturing a magnetic recording medium comprising a magnetic layer on a nonmagnetic support, which comprises:

preparing a coating material for forming a magnetic layer via a step of mixing the above alumina dispersion with a magnetic liquid comprising ferromagnetic powder, solvent, and a binder; and

forming a magnetic layer by coating the coating material for forming a magnetic layer that has been prepared on a nonmagnetic support.

A still further aspect of the present invention relates to a particulate magnetic recording medium manufactured by the above manufacturing method.

The present invention makes it possible to stably disperse alumina to a high degree, which has been difficult to achieve with the conventional techniques. Thus, the present invention can provide an alumina dispersion that is suited to the manufacturing of particulate magnetic recording media for high-density recording.

Other exemplary embodiments and advantages of the present invention may be ascertained by reviewing the present disclosure.

### DETAILED DESCRIPTION OF THE EMBODIMENTS

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description making apparent to those skilled in the art how several forms of the present invention may be embodied in practice.

The alumina dispersion according to an aspect of the present invention, that is employed for manufacturing a particulate magnetic recording medium, is rendered as a coating material for manufacturing a particulate magnetic recording medium, or is employed in the preparation thereof. In one embodiment, it is employed to prepare a coating material for forming a magnetic layer of a particulate magnetic recording medium. In another embodiment, it can be rendered as a nonmagnetic layer coating material of a particulate magnetic recording medium, or employed in the preparation thereof. The alumina dispersion of an aspect of the present invention contains alumina and a solvent, as well as a dispersing agent in the form of an aromatic hydrocarbon compound having a phenolic hydroxyl group, making it possible to achieve alumina that is in a stable, highly dispersed state. In this context, the term “dispersing agent” means a component that, when present, enhances the dispersion or dispersion stability of alumina relative to when the component is not present. However, the alumina dispersion of an aspect of the present invention essentially does not contain ferromagnetic powder. This means that the alumina dispersion of an aspect of the present invention itself is not a coating material for forming a magnetic layer containing ferromagnetic powder and alumina as an abrasive component, but when employed to prepare a coating material for forming a magnetic layer, is an abrasive liquid that is subsequently added after being dispersed separately from the magnetic liquid containing the ferromagnetic powder, solvent, and binder. Further, “essentially does not contain (or comprise)” means that it is not added as a structural component of the above dispersion, and the presence of trace amounts of ferromagnetic powder as unintentionally contained impurities is permitted. For example, in a common coating material for forming a magnetic layer, more ferromagnetic powder is contained than abrasive component. However, the alumina dispersion of an aspect of the present invention is not such a coating material for forming a magnetic layer.

The alumina dispersion of an aspect of the present invention will be described in greater detail below.

Dispersing Agent

The dispersing agent contained in the alumina dispersion of an aspect of the present invention is an aromatic hydrocarbon compound having a phenolic hydroxyl group. The term “phenolic hydroxyl group” refers to a hydroxyl group that is directly bonded to an aromatic ring. As regards the use of aromatic hydrocarbon compounds having phenolic hydroxyl groups in the preparation of a coating material for forming the magnetic layer of a particulate magnetic recording medium, Japanese Unexamined Patent Publication (KOKAI) Heisei No. 3-292617, which is expressly incorporated herein by reference in its entirety, proposes the use of dihydroxynaphthalene as a component capable of preventing the deterioration due to oxidation of ferromagnetic metal particles employed in magnetic recording. However, the fact that aromatic hydrocarbon compounds having phenolic hydroxyl groups, such as dihydroxynaphthalene, are components that contribute to enhancing the dispersion of alumina and its dispersion stability was discovered by the present inventor.

The aromatic ring contained in aromatic hydrocarbon compounds having phenolic hydroxyl groups can be of a monocyclic or polycyclic structure, or a fused ring. From the perspectives of enhancing the dispersion and dispersion stability of alumina, an aromatic hydrocarbon compound contained a benzene ring or naphthalene ring is desirable. The aromatic hydrocarbon compound can have substituents in addition to phenolic hydroxyl groups. From the perspective of availability of compound, examples of substituents in addition to the phenolic hydroxyl groups are halogen atoms, alkyl groups, alkoxyl groups, amino groups, acyl groups, nitro groups, nitroso groups, and hydroxyalkyl groups. In compounds having substituents other than phenolic hydroxyl groups, there is a tendency that compounds having electron-releasing substituents with a Hammett's substituent constant of equal to or less than 0.4 are advantageous for the dispersion of alumina. In this regard, substituents with an electron-releasing property of equal to or greater than that of halogen atom, specifically, halogen atoms, alkyl groups, alkoxyl groups, amino groups, and hydroxyalkyl groups are preferred.

One, two, three, or more phenolic hydroxyl groups can be contained in the aromatic hydrocarbon compound. When the aromatic ring comprised by the aromatic hydrocarbon compound is a naphthalene ring, two or more phenolic hydroxyl groups are desirably contained, and two are preferably contained. That is, the compound denoted by general formula (1) below is desirable as an aromatic hydrocarbon compound comprising a naphthalene ring as an aromatic ring.

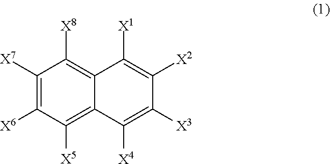

(In general formula (1), two from among X¹ to X⁸ denote hydroxyl groups and each of the remaining portions independently denotes a hydrogen atom or a substituent.)

In the compound denoted by general formula (1), the substitution positions of the two hydroxyl groups (phenolic hydroxyl groups) are not specifically limited.

In the compound denoted by general formula (1), two from among X¹ to X⁸ denote hydroxyl groups (phenolic hydroxyl groups), and each of the remaining portions independently denotes a hydrogen atom or a substituent. The portions other than the two hydroxyl groups among X¹ to X⁸ can all be hydrogen atoms, or some portion thereof or all can denote substituents. Examples of substituents are the substituents given above. Phenolic hydroxyl groups can be included as the substituents in addition to the two hydroxyl groups. However, from the perspectives of dispersion and enhancing dispersion, they are desirably not phenolic hydroxyl groups. That is, the compound denoted by general formula (1) is desirably a dihydroxynaphthalene or a derivative thereof, among which 2,3-dihydroxynaphthalene or a derivative thereof is desirable. Examples of substituents that are desirable as the substituents denoted by X¹ to X⁸ are selected from the group consisting of halogen atoms (such as chlorine atoms and bromine atoms), amino groups, alkyl groups with 1 to 6 (desirably 1 to 4) carbon atoms, methoxy groups, ethoxy groups, acyl groups, nitro groups, nitroso groups, and —CH₂OH groups.

An aromatic hydrocarbon compound containing an aromatic ring in the form of a benzene ring desirably contains one or more phenolic hydroxyl groups, preferably one or two. General formula (2) denotes such an aromatic hydrocarbon compound.

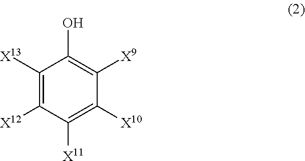

(In general formula (2), each of X⁹ to X¹³ independently denotes a hydrogen atom or a substituent.)

In general formula (2), X⁹ to X¹³ can all denote hydrogen atoms, or some portion thereof or all can denote substituents. Examples of substituents are the phenolic hydroxyl groups and substituents set forth above. Examples of desirable substituents are selected from the group consisting of hydroxyl groups, carboxyl groups, and alkyl groups having 1 to 6 (preferably 1 to 4) carbon atoms.

Specific desirable examples of the aromatic hydrocarbon compound described above are dihydroxylnaphthalenes, phenols, hydroxybenzoic acids, and derivatives thereof. More specific examples are the various aromatic hydrocarbon compounds disclosed in Examples further below.

One of the above aromatic hydrocarbon compounds can be employed alone, or two or more can be employed in combination as dispersing agents. Each of these aromatic hydrocarbon compounds can be synthesized by known methods, and some are available as commercial products.

Alumina

Alumina is a powder comprised mainly of aluminum oxide. Alumina comes mainly in two crystalline forms: an α-phase and a γ-phase, either of which can be employed as the alumina used in the particulate magnetic recording medium. The use of alumina of the alpha crystal form (α-alumina) is desirable in terms of a high degree of hardness, abrasive properties, and enhancing coating strength. The rate of alpha conversion rate in α-alumina is desirably equal to or greater than 50% from the perspective of hardness. These aluminas can all be prepared by known methods or are available as commercial products. Examples of the names of products made by Sumitomo Chemical are: A-26, A-21, A-21F2I, AC-21, AR-22, AM-28, CTS-FG, H-19, AMS-5, AL-40, ALC-27, ARL-41, ALM-44-01, ACLM-27, EA-1, AES-21, P-10, Harimick 25, HIT-50, HIT-55, HIT-60A, HIT-80, HIT-82, HIT-100, HIT-102, HIT-5010, HIT-70, ACM-27B, A-260, H-200, AKP-15, AKP-20, AKP-20C, AKP-30, AKP-46, AKP-50, AKP-3000, AKQ10, CAH-3000, AKP-700, AKP-5N, AKX-5, AKP-G008, CAH-G00, AKS-GT00, AKS-G312, AA-03. The present invention is not limited thereto.

Microparticulate alumina is suitable as the alumina employed as a magnetic layer component to achieve a high degree of abrasiveness without greatly wearing down the head. The specific surface area (S_{BET}) measured by the BET method is an indicator of the particle size of alumina. The S_{BET} specific surface area desirably falls within a range of equal to or higher than 14 m²/g, preferably equal to or higher than 16 m²/g, and more preferably, equal to or higher than 18 m²/g. The primary particle size of alumina with an S_{BET} of less than 14 m²/g is about equal to or higher than 110 nm as a spherical approximation, and tends to be coarsely abrasive. An upper limit of the specific surface area of, for example, an S_{BET} of equal to or less than 40 m²/g makes it possible to achieve both a high degree of abrasiveness and inhibited head abrasion. Alumina with an S_{BET} of equal to or less than 40 m²/g can be readily and stably dispersed to a high degree according to an aspect of the present invention.

Solvent

The solvent contained in the alumina dispersion of an aspect of the present invention is not specifically limited. The use of a solvent that readily dissolves the above dispersing agent is desirable. From this perspective, organic solvents are desirable, among which ketone solvents are preferred. Ketone solvents are suitable solvents in the present invention from the perspective of general use as solvents in coating materials for forming particulate magnetic recording media. Specific examples of ketone solvents are: acetone, methyl ethyl ketone, methyl isobutyl ketone, and cyclohexanone. In addition to ketone solvents, it is also possible to employ methanol, ethanol, isopropanol, toluene, xylene, ethylbenzene, ethyl formate, ethyl acetate, butyl acetate, dioxane, tetrahydrofuran, dimethyl formamide, and the like. Since the dispersing agent is poorly soluble in water, it is undesirable to employ water alone as solvent.

Additional Components

The alumina dispersion of an aspect of the present invention contains essential components in the form of alumina, a solvent, and the above dispersing agent. It also desirably contains a resin component that is capable of functioning as a binder in a particulate magnetic recording medium. By covering the surface of the alumina with a binder component, it is possible to further enhance the dispersion and dispersion stability of the alumina. From this perspective, the use of a resin component with good adsorption to alumina is desirable. A specific example is the use of a resin component having a functional group with polarity (a polar group) being adsorption points on alumina. Examples of such polar groups are sulfo groups, phosphoric acid groups, hydroxy groups, carboxyl groups, and salts thereof. Sulfo groups with high adsorptive strength and their salts are desirable. To further enhance dispersion and dispersion stability, the quantity of polar groups in the resin component is desirably 50 to 400 meq/kg, preferably 60 to 330 meq/kg.

Various resins that are employed as binders in particulate magnetic recording media, such as polyurethane resins and vinyl chloride resins, can be employed as the resin component. Of these, from the perspective of the dispersion and dispersion stability of alumina, the use of a polyurethane resin is desirable. Among the polyurethane resins, polyether polyurethane and polyester polyurethane resins are suitably employed. A polyurethane resin is a desirable resin component from the perspective of good solubility in ketone solvents, which are suitable solvents in an aspect of the present invention.

The alumina dispersion of an aspect of the present invention as set forth above can be prepared by simultaneously or successively mixing and dispersing the above components. Glass beads can be used in dispersion. In addition to such glass beads, high specific gravity dispersion media in the form of zirconia beads, titania beads, steel beads, and alumina beads are suitable. These dispersion media are employed by optimizing the particle size and fill rate thereof. A known dispersion device can be employed. The use of a ratio of 2 to 20 weight parts of the above dispersing agent, 150 to 970 weight parts of the solvent, and 5 to 30 weight parts of the resin component per 100 weight parts of alumina is desirable from the perspectives of alumina dispersion and dispersion stability.

As set forth above, the alumina dispersion of an aspect of the present invention can be used to prepare a coating material for forming a magnetic layer of a particulate magnetic recording medium. That is, an aspect of the present invention provides a method of manufacturing a particulate magnetic recording medium comprising a magnetic layer on a nonmagnetic support, comprising the steps of preparing a coating material for forming a magnetic layer via a step of mixing the alumina dispersion of an aspect of the present invention with a magnetic liquid containing ferromagnetic powder, solvent, and binder; and forming a magnetic layer by coating the coating material for forming a magnetic layer that has been prepared on a nonmagnetic support. An aspect of the present invention also provides a particulate magnetic recording medium obtained by the above manufacturing method.

When the alumina dispersion and the magnetic liquid that have been separately prepared as set forth above are mixed and the dispersion stability of the alumina is low, there are sometimes cases where the dispersion of the alumina decreases and aggregation occurs due to shock such as dilution when the alumina is diluted within the system by mixing with the magnetic liquid. By contrast, the alumina dispersion of an aspect of the present invention can contain alumina in a stably dispersed state. Thus, the dispersion of the alumina would not be greatly diminished by mixing with the magnetic liquid. As a result, it is possible to prepare a coating material for forming a magnetic layer in which alumina is highly dispersed. The magnetic layer that is formed using the coating material for forming a magnetic layer that has thus been prepared can afford high surface smoothness and is suitable for high-density recording.

The magnetic recording medium of an aspect of the present invention and the method of manufacturing it will be described in greater detail below.

The details of the alumina dispersion that is employed to prepare the above coating material for forming a magnetic layer are as set forth above. The magnetic liquid that is mixed with the alumina dispersion contains at least ferromagnetic powder, solvent, and binder. In addition, it can also contain as needed known additives that are commonly employed in particulate magnetic recording media. Examples of ferromagnetic powders are acicular ferromagnetic powders, platelike magnetic powders, and spherical or elliptical magnetic powders. From the perspective of high-density recording, the average major axis length of an acicular magnetic powder is desirably equal to or more than 20 nm and equal to or less than 50 nm, preferably equal to or more than 20 nm and equal to or less than 45 nm. The average plate diameter of a platelike magnetic powder is desirably equal to or more than 10 nm and equal to or less than 50 nm as a hexagonal plate diameter. When reproduction is conducted with a magnetoresistive head, noise should be kept low and the plate diameter is desirably equal to or less than 40 nm The plate diameter is desirably kept within the stated range to eliminate thermal fluctuation and achieve stable magnetization. Due to low noise, the stated range is suited to high-density magnetic recording. From the perspective of high-density recording, a spherical or elliptical magnetic powder desirably has an average diameter of equal to or greater than 10 nm and equal to or less than 50 nm.

The average particle size of the ferromagnetic powder can be measured by the following method.

Particles of ferromagnetic powder are photographed at a magnification of 100,000-fold with a model H-9000 transmission electron microscope made by Hitachi and printed on photographic paper at a total magnification of 500,000-fold to obtain particle photographs. The targeted magnetic material is selected from the particle photographs, the contours of the powder material are traced with a digitizer, and the size of the particles is measured with KS-400 image analyzer software from Carl Zeiss. The size of 500 particles is measured. The average value of the particle sizes measured by the above method is adopted as an average particle size of the ferromagnetic powder.

The size of a powder such as the magnetic material (referred to as the “powder size” hereinafter) in the present invention is denoted: (1) by the length of the major axis constituting the powder, that is, the major axis length, when the powder is acicular, spindle-shaped, or columnar in shape (and the height is greater than the maximum major diameter of the bottom surface); (2) by the maximum major diameter of the tabular surface or bottom surface when the powder is tabular or columnar in shape (and the thickness or height is smaller than the maximum major diameter of the tabular surface or bottom surface); and (3) by the diameter of an equivalent circle when the powder is spherical, polyhedral, or of unspecified shape and the major axis constituting the powder cannot be specified based on shape. The “diameter of an equivalent circle” refers to that obtained by the circular projection method.

The average powder size of the powder is the arithmetic average of the above powder size and is calculated by measuring five hundred primary particles in the above-described method. The term “primary particle” refers to a nonaggregated, independent particle.

The average acicular ratio of the powder refers to the arithmetic average of the value of the (major axis length/minor axis length) of each powder, obtained by measuring the length of the minor axis of the powder in the above measurement, that is, the minor axis length. The term “minor axis length” means the length of the minor axis constituting a powder for a powder size of definition (1) above, and refers to the thickness or height for definition (2) above. For (3) above, the (major axis length/minor axis length) can be deemed for the sake of convenience to be 1, since there is no difference between the major and minor axes.

When the shape of the powder is specified, for example, as in powder size definition (1) above, the average powder size refers to the average major axis length. For definition (2) above, the average powder size refers to the average plate diameter, with the arithmetic average of (maximum major diameter/thickness or height) being referred to as the average plate ratio. For definition (3), the average powder size refers to the average diameter (also called the average particle diameter).

Reference can be made to [0097] to [0110] of Japanese Unexamined Patent Publication (KOKAI) No. 2009-96798, which is expressly incorporated herein by reference in its entirety, for the details of the above-described magnetic powders.

Examples of additives employed in the manufacturing of the magnetic layer coating material are lubricants, dispersing agents, dispersion adjuvants, antifungal agents, antistatic agents, oxidation-inhibiting agents, carbon black, and solvents. For specific details of these additives, for example, reference can be made to paragraphs [0111] to [0115] and [0117] to [0121] in Japanese Unexamined Patent Publication (KOKAI) No. 2009-96798. A curing agent can be employed to increase the coating strength of the magnetic layer in preparing the coating material for forming a magnetic layer. For details of curing agents that can be employed reference can be made to paragraphs [0093] and [0094] of Japanese Unexamined Patent Publication (KOKAI) No. 2009-96798. The curing agent can be added during preparation of the magnetic liquid, simultaneously with mixing of the magnetic liquid and the alumina dispersion, or subsequently to the mixture that has been prepared.

The solid component concentration of the magnetic material is desirably about 10 to 50 weight percent from the perspectives of dispersion of granular substances (ferromagnetic powder and the like) in the magnetic liquid and ease of preparing the magnetic liquid. A resin component in the form of a known, commonly employed thermoplastic resin, thermosetting resin, reactive resin, or mixture thereof can be employed as the binder employed to prepare the magnetic liquid for preparing a particulate magnetic recording medium. The magnetic liquid can be prepared by mixing the above components in a known stirrer or dispersing apparatus such as a disperser or sand mill. The magnetic liquid that has been prepared is mixed with the alumina dispersion set forth above. Taking into account the abrasiveness and fill rate of the ferromagnetic powder in the magnetic layer that is formed, the magnetic liquid and alumina dispersion are desirably mixed in a proportion of 1 to 20 weight parts of alumina per 100 weight parts of ferromagnetic powder. From the perspective of the dispersion and dispersion stability of the alumina in the coating material for forming the magnetic layer, the magnetic liquid and alumina dispersion are desirably mixed in proportions yielding 2,300 to 120,000 weight parts of solvent per 100 weight parts of alumina. Either simultaneously or after mixing of the magnetic liquid and the alumina dispersion, the above-described additives, curing agent, and other optional components can be added. After mixing the magnetic liquid and the alumina dispersion, it is possible to use ultrasonic dispersion, sand mill dispersion, or the like to obtain a coating material for forming a magnetic layer in which granular substances including alumina and ferromagnetic powder have been dispersed to a high degree.

In the method of manufacturing a magnetic recording medium of an aspect of the present invention, with the exception that the coating material for forming a magnetic layer set forth above is used to form a magnetic layer, known techniques relating to particulate magnetic recording media can be employed without limitation. For example, the coating material for forming a magnetic layer can be coated to a prescribed thickness to form a magnetic layer on the running surface of a nonmagnetic support or on the running surface of a nonmagnetic layer that has been formed on a nonmagnetic support. Here, multiple coating materials for forming magnetic layers can be sequentially or simultaneously applied in a multilayer coating, or a coating material for forming a nonmagnetic layer and a coating material for forming a magnetic layer can be sequentially or simultaneously applied in a multilayer coating. The coating apparatus employed to apply the coating materials for forming the various layers can be an air doctor coater, a blade coater, a rod coater, an extrusion coater, an air knife coater, a squeeze coater, a dip coater, a reverse roll coater, a transfer roll coater, a gravure coater, a kiss coater, a cast coater, a spray coater, a spin coater, or the like. In this regard, reference can be made for example to the “Most Recent Coating Techniques” published by the Sogo Gijutsu Center (May 31, 1983), which is expressly incorporated herein by reference in its entirety. For details of the coating step, reference can be made to paragraphs [0067] and [0068] of Japanese Unexamined Patent Publication (KOKAI) No. 2004-295926, which is expressly incorporated herein by reference in its entirety. Following the coating step, the medium can be subjected to various post-processing such as a drying treatment, a magnetic layer orientation treatment, and a surface smoothing treatment (calendering treatment). For details on the above treatments, reference can be made to paragraphs [0070] to [0073] of Japanese Unexamined Patent Publication (KOKAI) No. 2004-295926.

The layer structure of the magnetic recording medium of an aspect of the present invention desirably comprises a nonmagnetic support that is 3 to 80 μm in thickness. The thickness of the magnetic layer can be optimized based on the saturation magnetization of the magnetic head employed, the head gap length, and the bandwidth of the recording signal. From the perspective of achieving high capacity, it is desirably 10 to 100 nm, preferably 20 to 80 nm. A single magnetic layer will suffice, but the magnetic layer can be divided into two or more layers of differing magnetic characteristics. A known multilayer magnetic layer structure can be applied. The nonmagnetic layer is desirably 0.2 to 3.0 μm, preferably 0.3 to 2.5 μm, and more preferably, 0.4 to 2.0 μm in thickness. When a nonmagnetic layer is present in the magnetic recording medium of the present invention, the nonmagnetic layer will produce its effect so long as it is essentially nonmagnetic. For example, even when impurities or unintended trace quantities of magnetic powder are contained, the effect of the present invention will be achieved and the structure can be considered to be essentially identical to the magnetic recording medium of the present invention. The phrase “essentially identical” means that the residual magnetic flux density of the nonmagnetic layer is equal to or less than 10 mT (1000 G) or the coercivity is equal to or less than 7.96 A/m (100 Oe), with no residual magnetic flux density or coercivity desirably being present.

In addition to the above layers, the magnetic recording medium of an aspect of the present invention can comprise optional layers that can be formed in the particulate magnetic recording medium, such as a backcoat layer and a smoothing layer. Additionally, known techniques relating to particulate magnetic recording media, including those described in Japanese Unexamined Patent Publication (KOKAI) Nos. 2004-295926 and 2009-96798, can be applied in the method of manufacturing a magnetic recording medium of an aspect of the present invention.

The present invention makes it possible to prevent alumina from aggregating and forming coarse particles in the magnetic layer. Thus, it is possible to obtain a particulate magnetic coating medium having high surface smoothness that is suitable as a magnetic recording medium for high-density recording.

### EXAMPLES

The present invention will be described in detail below based on examples. However, the present invention is not limited to the examples. The terms “parts” and “percent” given in Examples are weight parts and weight percent unless otherwise stated.

1. Examples and Comparative Examples Relating to Alumina Dispersion

### Example 1

To 100 weight parts of alumina powder (HIT-70 made by Sumitomo Chemical) with an alpha conversion rate of about 65% and a BET specific surface area of 17.4 m²/g were admixed 3 weight parts of 2,3-dihydroxynaphthalene (made by Tokyo Chemical), 31.3 weight parts of a 32 percent solution (mixed solvent of methyl ethyl ketone and toluene) of polyester polyurethane resin (UR-4800 made by Toyobo (quantity of polar groups: 80 meq/kg)) comprising polar groups in the form of SO₃Na groups, and 570 parts of solvent in the form of a 1:1 (w/w) mixed solution of methyl ethyl ketone and cyclohexanone. The mixture was dispersed for 5 hours in a paint shaker in the presence of zirconia beads. Following dispersion, the dispersion liquid and the beads were separated with mesh, yielding an alumina dispersion. The alumina dispersion obtained was evaluated by the following methods.

Evaluation Methods

### 1. Dispersion Evaluation Part 1: Evaluation of Dispersion by Dynamic Light Scattering

The dispersion of the alumina dispersion obtained was evaluated based on the average size of the particles in the liquid by dynamic light scattering. The average particle size that was measured was an indicator of the final degree of dispersion of the dispersion product. Specifically, the dispersion obtained was diluted with a 1:1 (w/w) mixed solution of methyl ethyl ketone and cyclohexanone to a solid component of 0.2 weight percent and ultrasonically dispersed for 30 minutes, at which point measurement was conducted. An LB-500 dynamic light scattering particle size analyzer made by Horiba was employed in the measurement. The measurement was conducted at a sample refractive index of 1.66, a dispersion medium refractive index of 1.409, and a dispersion medium viscosity of 1.0501 mPa·s. The average particle size was calculated as the arithmetic average diameter.

2. Dispersion Stability Evaluation Part 1

The alumina dispersion obtained was left standing for one week in a 23° C.<, 50% RH atmosphere. The dispersion was visually observed before and after standing and evaluated on the following scale:
A No change whatsoever
B A transparent supernatant liquid was observed
C Aggregates were observed

3. Dispersion Stability Evaluation Part 2: Dispersion Stability Evaluation by the Optical Diffraction Method

The dispersion obtained was subjected to particle size measurement by the optical diffraction method to evaluate dispersion stability. An MT-3300 microtrack made by Nikkiso was employed in evaluation. With this device, the alumina dispersion was dripped into a solvent circulating through the interior of the measurement device and the particle size and particle size distribution were measured. No great change in particle size or particle size distribution due to dilution was observed when dispersion stability was good. When dispersion stability was poor, the shock due to dilution and the like caused aggregation, resulting in changes such as an increase in the average particle size, and the particle size distribution exhibited two peaks. Specifically, a circulating solvent in the form of methyl ethyl ketone was employed, into which the alumina dispersion was dripped to a concentration permitting measurement. Measurement began at the point where the transmittance stabilized. Measurement was conducted at a sample refractive index of 1.77 and a solvent refractive index of 1.38. The particle size was calculated as the 50% cumulative particle size (D50).

### Example 2

With the exception that the quantity of 2,3-dihydroxynaphthalene added in the preparation of the alumina dispersion of Example 1 was changed to 10 parts, an alumina dispersion was prepared and evaluated by the same method as in Example 1.

### Comparative Example 1

With the exception that the quantity of 2,3-dihydroxynaphthalene added in the preparation of the alumina dispersion of Example 1 was changed to 0 parts, an alumina dispersion was prepared and evaluated by the same method as in Example 1.

The evaluation results obtained are given in Table 1.

TABLE 1

| | Average particle diameter | | D50 (μm) by |
|---|---|---|---|
| | by dynamic light | Dispersion | optical diffraction |
| | scattering (nm) | stability | method |
| Ex. 1 | 84.0 | A | 0.133 |
| Ex. 2 | 78.9 | A | 0.134 |
| Comp. Ex. 1 | 87.0 | B | 0.223 |

### Example 3

With the exception that alumina powder (HIT-80, made by Sumitomo Chemical) with an alpha conversation rate of about 60% and a specific surface area of 18.8 m²/g was employed instead of the alumina powder employed in Example 1, an alumina dispersion was prepared and evaluated by the same method as in Example 1.

### Example 4

With the exception that the quantity of 2,3-dihydroxynaphthalene added in the preparation of the alumina dispersion of Example 3 was changed to 10 parts, an alumina dispersion was prepared and evaluated by the same method as in Example 3.

### Example 5

With the exception that the 2,3-dihydroxynaphthalene added in the preparation of the alumina dispersion of Example 4 was changed to 1,4-dihydroxynaphthalene, an alumina dispersion was prepared and evaluated by the same method as in Example 4.

### Example 6

With the exception that the 2,3-dihydroxynaphthalene added in the preparation of the alumina dispersion of Example 4 was changed to 1,2-dihydroxynaphthalene, an alumina dispersion was prepared and evaluated by the same method as in Example 4.

### Example 7

With the exception that the 2,3-dihydroxynaphthalene added in the preparation of the alumina dispersion of Example 4 was changed to 2,7-dihydroxynaphthalene, an alumina dispersion was prepared and evaluated by the same method as in Example 4.

### Example 8

With the exception that the 2,3-dihydroxynaphthalene added in the preparation of the alumina dispersion of Example 4 was changed to 1,5-dihydroxynaphthalene, an alumina dispersion was prepared and evaluated by the same method as in Example 4.

### Example 9

With the exception that the 2,3-dihydroxynaphthalene added in the preparation of the alumina dispersion of Example 4 was changed to 1,3-dihydroxynaphthalene, an alumina dispersion was prepared and evaluated by the same method as in Example 4.

### Example 10

With the exception that the 2,3-dihydroxynaphthalene added in the preparation of the alumina dispersion of Example 4 was changed to 1,7-dihydroxynaphthalene, an alumina dispersion was prepared and evaluated by the same method as in Example 4.

### Example 11

With the exception that the 2,3-dihydroxynaphthalene added in the preparation of the alumina dispersion of Example 4 was changed to 1,6-dihydroxynaphthalene, an alumina dispersion was prepared and evaluated by the same method as in Example 4.

### Example 12

With the exception that the 2,3-dihydroxynaphthalene added in the preparation of the alumina dispersion of Example 4 was changed to 2,6-dihydroxynaphthalene, an alumina dispersion was prepared and evaluated by the same method as in Example 4.

### Example 13

With the exception that the 2,3-dihydroxynaphthalene added in the preparation of the alumina dispersion of Example 4 was changed to 4-tert-butylphenol, an alumina dispersion was prepared and evaluated by the same method as in Example 4.

### Example 14

With the exception that the 2,3-dihydroxynaphthalene added in the preparation of the alumina dispersion of Example 4 was changed to catechol(1,2-benzenediol), an alumina dispersion was prepared and evaluated by the same method as in Example 4.

### Example 15

With the exception that the 2,3-dihydroxynaphthalene added in the preparation of the alumina dispersion of Example 4 was changed to resorcinol(1,3-benzenediol), an alumina dispersion was prepared and evaluated by the same method as in Example 4.

### Example 16

With the exception that the 2,3-dihydroxynaphthalene added in the preparation of the alumina dispersion of Example 4 was changed to hydroquinone(1,4-benzenediol), an alumina dispersion was prepared and evaluated by the same method as in Example 4.

### Example 17

With the exception that the 2,3-dihydroxynaphthalene added in the preparation of the alumina dispersion of Example 4 was changed to 2-hydroxybenzoic acid, an alumina dispersion was prepared and evaluated by the same method as in Example 4.

### Example 18

With the exception that the 2,3-dihydroxynaphthalene added in the preparation of the alumina dispersion of Example 4 was changed to 3-hydroxybenzoic acid, an alumina dispersion was prepared and evaluated by the same method as in Example 4.

### Example 19

With the exception that the 2,3-dihydroxynaphthalene added in the preparation of the alumina dispersion of Example 4 was changed to 4-hydroxybenzoic acid, an alumina dispersion was prepared and evaluated by the same method as in Example 4.

### Example 20

With the exception that the 2,3-dihydroxynaphthalene added in the preparation of the alumina dispersion of Example 4 was changed to 2,6-dibromo-1,5-dihydroxynaphthalene, an alumina dispersion was prepared and evaluated by the same method as in Example 4.

### Example 21

With the exception that vinyl chloride resin with SO₃K groups (MR-110T (quantity of polar groups: 75 meq/kg) made by Zeon Japan) was employed as resin in the preparation of the alumina dispersion of Example 4, an alumina dispersion was prepared and evaluated by the same method as in Example 4.

### Comparative Example 2

With the exception that the quantity of 2,3-dihydroxynaphthalene added in the preparation of the alumina dispersion of Example 3 was changed to 0 parts, an alumina dispersion was prepared and evaluated by the same method as in Example 3.

### Comparative Example 3

With the exception that the quantity of 2,3-dihydroxynaphthalene added in the preparation of the alumina dispersion of Example 21 was changed to 0 parts, an alumina dispersion was prepared and evaluated by the same method as in Example 21.

### Comparative Example 4

With the exception that the 2,3-dihydroxynaphthalene employed in the preparation of the alumina dispersion of Example 4 was replaced with phenylphosphonic acid, an alumina dispersion was prepared and evaluated by the same method as in Example 4.

### Comparative Example 5

With the exception that the 2,3-dihydroxynaphthalene employed in the preparation of the alumina dispersion of Example 4 was replaced with benzenesulfonic acid, an alumina dispersion was prepared and evaluated by the same method as in Example 4.

### Comparative Example 6

With the exception that the 2,3-dihydroxynaphthalene employed in the preparation of the alumina dispersion of Example 4 was replaced with trans-cinnamic acid, an alumina dispersion was prepared and evaluated by the same method as in Example 4.

### Comparative Example 7

With the exception that the 2,3-dihydroxynaphthalene employed in the preparation of the alumina dispersion of Example 4 was replaced with phthalic acid, an alumina dispersion was prepared and evaluated by the same method as in Example 4.

The evaluation results obtained are given in Table 2 below.

TABLE 2

| | Average particle | | D50 (μm) by |
|---|---|---|---|
| | diameter by dynamic | Dispersion | optical diffraction |
| | light scattering (nm) | stability | method |
| Ex. 3 | 77.7 | A | 0.148 |
| Ex. 4 | 69.4 | A | 0.101 |
| Ex. 5 | 72.9 | A | 0.134 |
| Ex. 6 | 72.6 | A | 0.131 |
| Ex. 7 | 71.1 | A | 0.119 |
| Ex. 8 | 70.2 | A | 0.112 |
| Ex. 9 | 71.9 | A | 0.126 |
| Ex. 10 | 71.2 | A | 0.119 |
| Ex. 11 | 70.3 | A | 0.112 |
| Ex. 12 | 70.4 | A | 0.114 |
| Ex. 13 | 71.8 | A | 0.125 |
| Ex. 14 | 70.7 | A | 0.116 |
| Ex. 15 | 72.0 | A | 0.125 |
| Ex. 16 | 71.6 | A | 0.123 |
| Ex. 17 | 71.4 | A | 0.122 |
| Ex. 18 | 71.2 | A | 0.120 |
| Ex. 19 | 71.5 | A | 0.122 |
| Ex. 20 | 71.1 | A | 0.119 |
| Ex. 21 | 70.1 | A | 0.140 |
| Comp. Ex. 2 | 81.3 | C | 6.051 |
| Comp. Ex. 3 | 83.0 | C | 7.003 |
| Comp. Ex. 4 | 564.8 | C | 4.798 |
| Comp. Ex. 5 | 69.0 | C | 5.617 |
| Comp. Ex. 6 | 73.1 | C | 6.292 |
| Comp. Ex. 7 | Evaluation could not | C | Evaluation could not |
| | be conducted because of | | be conducted |
| | coagulation settling. | | because of |
| | | | coagulation settling. |

### Example 22

With the exception that the alumina powder employed in Example 1 was replaced with alumina powder with an alpha conversion rate of about 55% and a specific surface area of 33.4 m²/g (HIT-100, made by Sumitomo Chemical), an alumina dispersion was prepared and evaluated by the same method as in Example 1.

### Example 23

With the exception that the quantity of 2,3-dihydroxynaphthalene added in the preparation of the alumina dispersion of Example 22 was changed to 10 parts, an alumina dispersion was prepared and evaluated by the same method as in Example 22.

### Example 24

With the exception that the 2,3-dihydroxynaphthalene employed in the preparation of the alumina dispersion of Example 23 was replaced with 4-tert-butylphenol, an alumina dispersion was prepared and evaluated by the same method as in Example 23.

### Example 25

With the exception that the 2,3-dihydroxynaphthalene employed in the preparation of the alumina dispersion of Example 23 was replaced with catechol, an alumina dispersion was prepared and evaluated by the same method as in Example 23.

### Example 26

With the exception that the 2,3-dihydroxynaphthalene employed in the preparation of the alumina dispersion of Example 23 was replaced with 3-hydroxybenzoic acid, an alumina dispersion was prepared and evaluated by the same method as in Example 23.

### Comparative Example 8

With the exception that the quantity of 2,3-dihydroxynaphthalene added in the preparation of the alumina dispersion of Example 22 was changed to 0 weight parts, an alumina dispersion was prepared and evaluated by the same method as in Example 22.

The evaluation results obtained are given in Table 3 below.

TABLE 3

| | Average particle | | |
|---|---|---|---|
| | diameter | | |
| | by dynamic light | | D50 (μm) |
| | scattering | Dispersion | by optical |
| | (nm) | stability | diffraction method |
| Ex. 22 | 74.5 | A | 0.114 |
| Ex. 23 | 68.9 | A | 0.107 |
| Ex. 24 | 71.3 | A | 0.127 |
| Ex. 25 | 70.1 | A | 0.122 |
| Ex. 26 | 76.4 | A | 0.137 |
| Comp. | Evaluation could not be | C | Evaluation could not be |
| Ex. 8 | conducted because of | | conducted because of |
| | coagulation settling. | | coagulation settling. |

Since the value of the particle size to be compared changes based on the original alumina powder, when comparing an Example and a comparative example employing the same alumina powder, it is possible to determine that the dispersion and dispersion stability of the alumina was enhanced by using an aromatic hydrocarbon compound having phenolic hydroxyl groups in each of Tables 1 to 3. Based on the results given in Tables 2 and 3, the use of aromatic hydrocarbon compounds having phenolic hydroxyl groups was determined to markedly improve the dispersion stability of microparticulate alumina with a specific surface area of 18 m²/g and above.

2. Examples and Comparative Examples Relating to Particulate Magnetic Recording Media

### Example 27

(1) Preparation of Magnetic Liquid
Hexagonal barium ferrite powder: 100 parts
   Composition excluding oxygen (molar ratio): Ba/Fe/Co/Zn=1/9/0.2/1
   Hc: 176 kA/m (2,200 Oe)
   Average plate diameter: 20 nm
   Average plate ratio: 3
   BET specific surface area: 65 m²/g
   σs: 49 A·m²/kg (49 emu/g)
   pH: 7
Dispersing agent phenylphosphonic acid: 5 parts
Polyvinyl chloride copolymer MR104 (made by Zeon Japan): 10 parts
Polyester polyurethane resin: 10 parts
Methyl ethyl ketone: 300 parts
Cyclohexanone: 300 parts
Carbon black (average particle size: 0.08 μm): 0.5 part

The various components were uniformly mixed in a disperser and then dispersed for 15 hours in a sand mill to prepare a coating material.

(2) Preparation of Coating Material for Forming Magnetic Layer

To the above magnetic liquid were added:
Alumina dispersion prepared in Example 4: 86 parts
Butyl stearate: 1.5 part
Stearic acid: 0.5 part
Methyl ethyl ketone: 100 parts
Cyclohexanone: 100 parts
Toluene: 6 parts
Polyisocyanate compound (Coronate 3041, made by Nippon
Polyurethane Industry): 5 parts.

The mixture was mixed and stirred for 20 minutes, ultrasonically treated, and filtered using a filter having an average pore diameter of 1 μm to prepare a coating material for forming a magnetic layer. The coating material for forming a magnetic layer was coated on a 6 μm polyethylene terephthalate film using an applicator with a 7 μm gap. It was then dried for one day or more at room temperature to form a magnetic layer 70 nm in thickness, after which surface smoothness evaluation was conducted.

Surface Smoothness Evaluation

The center surface average roughness Ra of the magnetic layer was obtained by the scanning white light interference method with a NewView 5022 general purpose three-dimensional surface profiler made by Zygo at a scan length of 5 μm with a 20-fold object lens and a 1.0-fold zoom lens using a measurement viewfield of 260 μm×350 μm, and processing the measured surface with a HPF: 1.65 μm LPF: 50 μm filter.

### Comparative Example 9

With the exception that 86 parts of the alumina dispersion prepared in Comparative Example 2 were employed instead of the 86 parts of alumina dispersion prepared in Example 4 in the preparation of the coating material for forming a magnetic layer in Example 27, a magnetic recording medium was fabricated and evaluated by the same method as in Example 27.

The results obtained are given in Table 4.

TABLE 4

| | Surface smoothness (Ra)/nm |
|---|---|
| Ex. 27 | 1.7 |
| Comp. Ex. 9 | 3.5 |

Based on the results given in Table 4, it was determined that an aspect of the present invention made it possible to obtain a particulate magnetic recording medium having high surface smoothness and suitable for high-density recording by forming a magnetic layer using an alumina dispersion having good dispersion and dispersion stability.

The present invention is useful in the field of manufacturing magnetic recording media for high-density recording.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any embodiments thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

What is claimed is:

1. An alumina dispersion, which is employed to manufacture a particulate magnetic recording medium, comprises alumina, a solvent, and a dispersing agent in the form of an aromatic hydrocarbon compound having a phenolic hydroxyl group, and essentially does not comprise ferromagnetic powder.

2. The alumina dispersion according to claim 1, wherein an aromatic ring contained in the aromatic hydrocarbon compound is a benzene ring or a naphthalene ring.

3. The alumina dispersion according to claim 1, wherein the aromatic hydrocarbon compound is selected from the group consisting of a compound denoted by general formula (1) and a compound denoted by general formula (2): 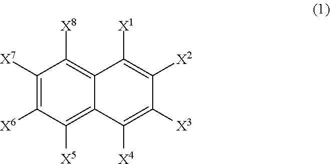
wherein, in general formula (1), two from among X¹ to X⁸ denote hydroxyl groups and each of the remaining portions independently denotes a hydrogen atom or a substituent; 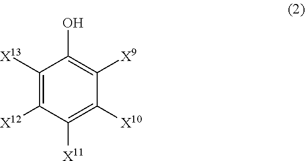
wherein, in general formula (2), each of X⁹ to X¹³ independently denotes a hydrogen atom or a substituent.

4. The alumina dispersion according to claim 1, wherein the solvent is an organic solvent.

5. The alumina dispersion according to claim 1, wherein the solvent comprises a ketone solvent.

6. The alumina dispersion according to claim 1, which further comprises a resin component.

7. The alumina dispersion according to claim 1, which further comprises a resin component selected from the group consisting of a polyurethane resin and a vinyl chloride resin.

8. The alumina dispersion according to claim 1, which is employed for preparation of a coating material for forming a magnetic layer of a particulate magnetic recording medium.

9. The alumina dispersion according to claim 1, wherein the alumina is α-alumina.

10. The alumina dispersion according to claim 1, wherein the aromatic hydrocarbon compound is selected from the group consisting of dihydroxylnaphthalene, phenol, hydroxybenzoic acid, and derivatives thereof.

11. The alumina dispersion according to claim 4, wherein the aromatic hydrocarbon compound is selected from the group consisting of dihydroxylnaphthalene, phenol, hydroxybenzoic acid, and derivatives thereof.

12. The alumina dispersion according to claim 5, wherein the aromatic hydrocarbon compound is selected from the group consisting of dihydroxylnaphthalene, phenol, hydroxybenzoic acid, and derivatives thereof.

13. The alumina dispersion according to claim 6, wherein the aromatic hydrocarbon compound is selected from the group consisting of dihydroxylnaphthalene, phenol, hydroxybenzoic acid, and derivatives thereof.

14. The alumina dispersion according to claim 7, wherein the aromatic hydrocarbon compound is selected from the group consisting of dihydroxylnaphthalene, phenol, hydroxybenzoic acid, and derivatives thereof.

15. The alumina dispersion according to claim 8, wherein the aromatic hydrocarbon compound is selected from the group consisting of dihydroxylnaphthalene, phenol, hydroxybenzoic acid, and derivatives thereof.

16. The alumina dispersion according to claim 9, wherein the aromatic hydrocarbon compound is selected from the group consisting of dihydroxylnaphthalene, phenol, hydroxybenzoic acid, and derivatives thereof.

17. The alumina dispersion according to claim 1, which comprises the dispersing agent in an amount ranging from 2 to 20 weight parts per 100 weight parts of the alumina.

18. The alumina dispersion according to claim 1, wherein a specific surface area by BET method of the alumina is equal to or higher than 14 m²/g.

19. A method of manufacturing a magnetic recording medium comprising a magnetic layer on a nonmagnetic support, which comprises:
preparing a coating material for forming a magnetic layer via a step of mixing an alumina dispersion with a magnetic liquid comprising ferromagnetic powder, solvent, and a binder, wherein the alumina dispersion comprises alumina, a solvent, and a dispersing agent in the form of an aromatic hydrocarbon compound having a phenolic hydroxyl group, and essentially does not comprise ferromagnetic powder; and
forming a magnetic layer by coating the coating material for forming a magnetic layer that has been prepared on a nonmagnetic support.

20. A particulate magnetic recording medium comprising a magnetic layer on a nonmagnetic support, which has been manufactured by a manufacturing method comprising:
preparing a coating material for forming a magnetic layer via a step of mixing an alumina dispersion with a magnetic liquid comprising ferromagnetic powder, solvent, and a binder, wherein the alumina dispersion comprises alumina, a solvent, and a dispersing agent in the form of an aromatic hydrocarbon compound having a phenolic hydroxyl group, and essentially does not comprise ferromagnetic powder; and
forming a magnetic layer by coating the coating material for forming a magnetic layer that has been prepared on a nonmagnetic support.
